(19) United States
(12) Patent Application Publication
(10) Pub. No.: US 2014/0130737 A1
(43) Pub. Date: May 15, 2014

(54) FUNCTIONAL PRINTING SYSTEM

(71) Applicant: Israel Schuster, Kiriyat Tivon (IL)

(72) Inventor: Israel Schuster, Kiriyat Tivon (IL)

(21) Appl. No.: 13/676,441

(22) Filed: Nov. 14, 2012

(51) Int. Cl. B05C 9/00

(52) U.S. Cl. CPC B05C 9/00
USPC 118/620

(57) ABSTRACT

A system or apparatus for forming a conductive pattern on a substrate (216) includes a thermal imaging head (220) that forms an image pattern on the substrate; functional material spraying element (224) that applies a functional material on the substrate which bonds with the image pattern; and applying a complementary process to enhance the functionality of the final product.

### CROSS REFERENCE TO RELATED APPLICATIONS

Reference is made to commonly-assigned copending U.S. Patent Application Serial No. ______ (Attorney Docket No. K001387US01NAB), filed herewith, entitled METHOD FOR FUNCTIONAL PRINTING SYSTEM, by Schuster; the disclosure of which is enclosed herein.

### FIELD OF THE INVENTION

The present invention relates to an apparatus for functional printing using computer to plate imaging technology.

### BACKGROUND OF THE INVENTION

Functional printing is a category of printing that uses commercial printing equipment to print circuits or electronic devices which have a function other than or in addition to visual display of information. An example of printed circuits can be printing radio frequency identification (RFID) on a package or a product. Another example may be printing an electronic circuit on a package which is capable to produce a musical clip when the package is opened.

There are several approaches for printing functional patterns on substrates including direct printing of functional inks. Other techniques use photolithography to mask and remove a pre-deposited functional layer.

### SUMMARY OF THE INVENTION

Briefly, according to one aspect of the present invention specific substrate characteristics are used to deposit patterns of functional materials on a surface, based on temperature differences. As the temperature of the substrate increases in a certain position, it allows faster diffusion of chemical elements or allows the attachment of chemical elements to its surface. One uses thermal writing devices (e.g. laser writing heads, thermal transfer writing heads) to form a thermal pattern on the substrate which, combined with the chemical environment, forms a pattern of functional chemical traces on the substrate. This pattern can be used as is for various applications such as forming hydrophilic/hydrophobic regions for printing processes. Another use is to form a pattern of a catalyst material that can be used for electro-less deposition of metal such as copper, and thus manufacture copper traces on the substrate.

There is a need for accurate deposition for functional material. The use of laser imaging or thermal transfer means on a substrate with a combination of sprayed material (such as gas) applied on the imaged areas. The gas molecules are diffused towards the laser heated substrate to create a chemical compound between the gas and the material deposited on the surface of the substrate. The gas is referred to as functional gas and creates a compound of traces on the substrate that is used to form conductive lines for example.

The invention and its objects and advantages will become more apparent in the detailed description of the preferred embodiment presented below.

### BRIEF DESCRIPTION OF THE DRAWINGS

FIG. 1 represents in diagrammatic form a prior art digital front end driving an imaging device;

FIG. 2 represents in diagrammatic form the imaging system disclosed herein; and

FIG. 3 represents in a diagrammatic form an electro-less coating machinery applied on a patterned substrate according to this invention.

### DETAILED DESCRIPTION OF THE INVENTION

The present invention will be directed in particular to elements forming part of, or in cooperation more directly with the apparatus in accordance with the present invention. It is to be understood that elements not specifically shown or described may take various forms well known to those skilled in the art.

While the present invention is described in connection with one of the embodiments, it will be understood that it is not intended to limit the invention to this embodiment. On the contrary, it is intended to cover alternatives, modifications, and equivalents as covered by the appended claims.

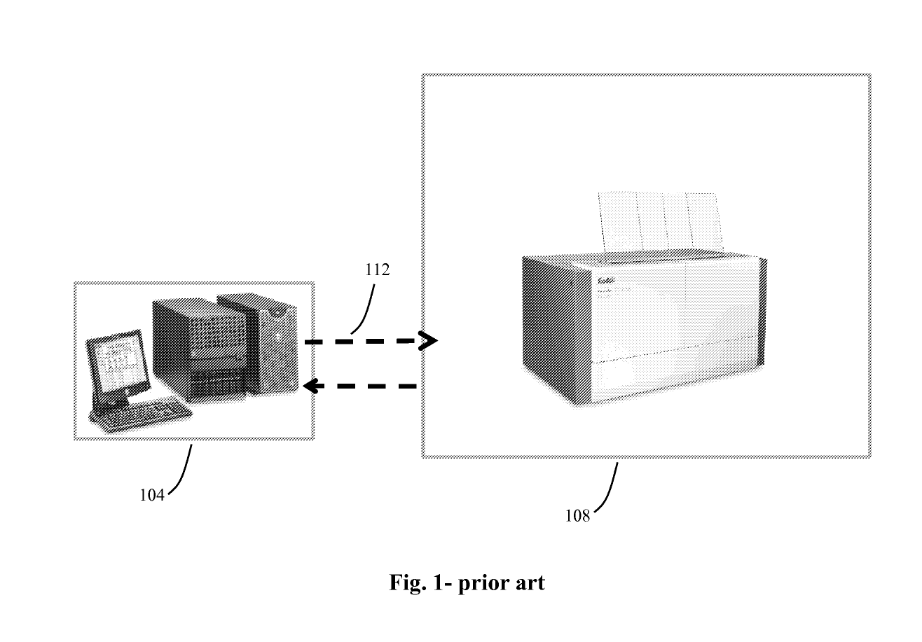

FIG. 1 shows a plate imaging device 108. The imaging device is driven by a digital front end (DFE) 104. The DFE receives imaging data in a digital form from desktop publishing (DTP) systems (not shown), and renders the digital information for imaging. The rendered information and imaging device control data are communicated between DFE 104 and imaging device 108 over interface line 112.

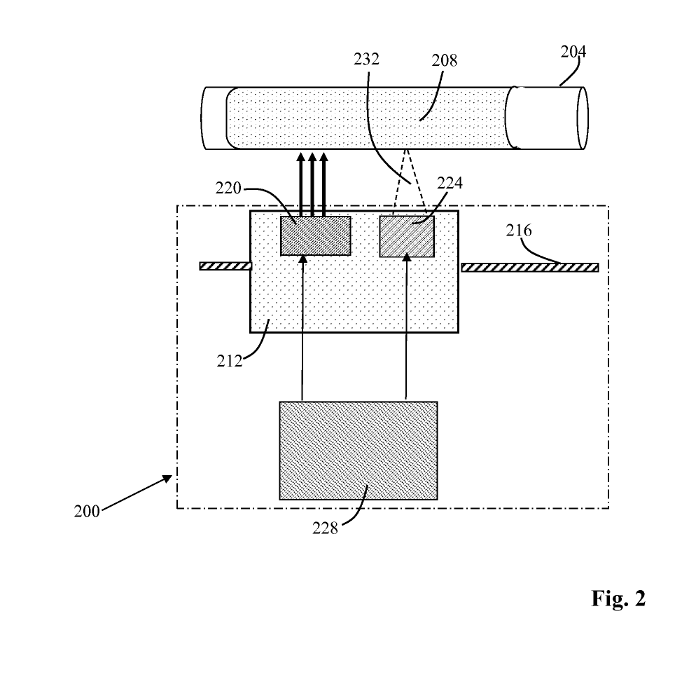

FIG. 2 shows an imaging system 200. The imaging system 200 includes an imaging carriage 212 on which a material spray element 224 is mounted along with an thermal imaging head 220. The sprayed material can be in a form of gas. The thermal imaging head 220 can be based on thermal transfer means or laser imaging components. The thermal imaging head 220 is designed to operate in a wavelength matching the substrate 208 characteristics. The imaging head 220 is configured to image on substrate 208 mounted on a rotating cylinder 204. The carriage 212 is adapted to move substantially in parallel to cylinder 204 guided by an advancement screw 216. Controller 228 controls patterning process of imaging head 220 and material emission from material spray element 224. A computer-to-plate device capable to image on flat surfaces, known as capstan devices, can be used as well for same purpose (not shown). An internal drum CTP (not shown) configuration can be used in conjunction with this invention as well.

Substrate 208 such as glass, metal or various polymeric materials is mounted on cylinder 204. Depending on the specific process being applied, a material spray element 224 deploys a material in proximity of substrate 208. The material deployment may be applied prior, during or after laser exposure. Imaging head 220 will image a pattern according to data received from DFE 104 on substrate 208. The CTP imaging head 220 will elevate the temperature of substrate 208, or opto-chemically modify its surface in the imaged areas to enable an efficient diffusion/bonding process of the functional sprayed material 232 molecules into substrate 208. Thus, the pattern created by imaging head 220 induces a doping pattern on substrate 208. For example, near IR (NIR) imaging head can be used for imaging on a specialized NIR absorbing polyethylene terephthalate (PET) substrate, while applying catalyst gas, such as 3-mercaptopropyltrimethoxysilane (MPTS) or palladium fine powder, to create traces of catalyst doping on substrate 208.

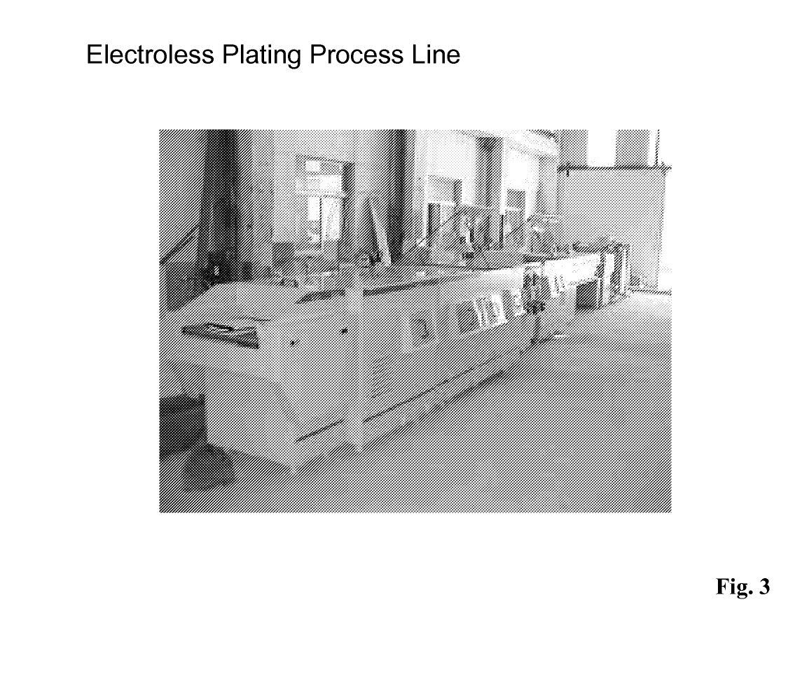

Followed the completion of the required patterning on substrate 208, a standard electro-less coating process is performed to build material traces such as copper, silver or nickel traces on substrate 208 by using electro-less coating machinery such as depicted in FIG. 3. These copper traces will form the pattern made by the CTP imaging head 220. [Yinxiang Lu, Qian Liang, Longlong Xue, Applied Surface Science, Volume 258, Issue 10, 1 Mar. 2012, Pages 4782-4787.]

Assuming the substrate heat capacity and density are ˜1.2 Jg-1K-1 and 1.37 gcm-3 respectively and assuming a penetration depth of 10 μm is required, energy in the vicinity of 1.644 mJ/cm2 will be needed for increasing substrate 208 temperature by 1K. Thus, to achieve 100K temperature an increase of 164 mJ/cm2 will be required, which within the working range of current CTP devices.

Patterning resolution is determined by the resolution of the CTP imaging head 220 and by substrate 208 characteristics such as thermal conductivity.

The invention has been described in detail with particular reference to certain preferred embodiments thereof, but it will be understood that variations and modifications can be effected within the scope of the invention.

### Parts List

104 digital front end (DFE)
108 imaging device
112 interface line
200 imaging system
204 rotating cylinder
208 imaging substrate
212 carriage
216 screw
220 thermal imaging head
224 material spray element
228 controller
232 sprayed material

1. A system or apparatus for forming a conductive pattern on a substrate comprising:
a thermal imaging head that forms an image pattern on said substrate;
functional material spraying element that applies a functional material on said substrate which bonds with said image pattern; and
applying a complementary process to enhance the functionality of the final product.

2. The system or apparatus according to claim 1 wherein said thermal imaging head is a laser imaging component.

3. The system or apparatus according to claim 1 wherein said thermal imaging head is comprised of a plurality of heating elements such as in thermal transfer head.

4. The system or apparatus according to claim 1 wherein said substrate is polyethylene terephthalate (PET) treated to absorb near intra-red (NIR) radiation.

5. The system or apparatus according to claim 2 wherein:
said laser imaging component is configured to image on said substrate; and
wherein said substrate is mounted on a capstan imaging device.

6. The system or apparatus according to claim 2 wherein:
said laser imaging component is configured to image on said substrate; and
wherein said substrate is mounted on an external drum.

7. The system or apparatus according to claim 2 wherein:
said laser imaging component is configured to image on said substrate; and
wherein said substrate is mounted on an internal drum.

8. The system or apparatus according to claim 2 wherein said laser imaging component is configured to image ultra violet.

9. The system or apparatus according to claim 2 wherein said laser imaging component is configured to image near infra-red (NIR).

10. The system or apparatus according to claim 1 wherein said functional material is 3-mercaptopropyltrimethoxysilane (MPTS).

11. The system or apparatus according to claim 1 wherein said functional material is palladium fine powder.

12. The system or apparatus according to claim 1 wherein said complementary process is electro-less deposition of a metal such as copper, nickel, or silver.
